(19) United States
(12) Patent Application Publication
(10) Pub. No.: US 2022/0058044 A1
(43) Pub. Date: Feb. 24, 2022

(54) COMPUTER SYSTEM AND MANAGEMENT METHOD

(71) Applicant: Hitachi, Ltd., Tokyo (JP)

(72) Inventors: Taisuke ONO, Tokyo (JP); Kohei TATARA, Tokyo (JP); Masakuni AGETSUMA, Tokyo (JP); Yoshinori OHIRA, Tokyo (JP)

(73) Assignee: Hitachi, Ltd.

(21) Appl. No.: 17/208,710

(22) Filed: Mar. 22, 2021

(30) Foreign Application Priority Data
Aug. 18, 2020 (JP) 2020-138246

(51) Int. Cl. G06F 9/455; G06F 9/451; G06F 9/50

(52) U.S. Cl. CPC G06F 9/45558; G06F 9/452; G06F 2009/45562; G06F 2009/45595; G06F 9/5077

(57) ABSTRACT

A managing node includes a processor and a storage unit. A processor rearranges virtual machines arranged in managed nodes with high usage rates to other managed nodes based on a standard deviation of the usage rate of a CPU in a plurality of managed nodes, and selects the managed nodes in which many images of operating systems used by the virtual machine are stored, arranges the virtual machine, and starts up the virtual machine when a client starts up the virtual machine.

### BACKGROUND OF THE INVENTION

### 1. Field of the Invention

The present invention relates to a computer system and a management method.

### 2. Description of the Related Art

There is an example in which a hyperconverged infrastructure (HCI) configuration is adopted for cost reduction in virtual desktop infrastructure (VDI) which integrates user desktop environments on a server by virtualization technology. Here, the HCI is a system that enables a plurality of processes to be implemented on one node by operating applications, middleware, management software, and containers as well as storage software on an operating system (OS) or a hypervisor installed on each node.

In the HCI configuration, virtual machines (VM) that provide the user desktop environments and storage control software are integrated on the node, and the VM accesses a volume provided by the storage control software to read an OS image.

At this time, it is desirable to arrange a VM on a node where the OS image used by the VM is stored in order to prevent an increase in disk access latency of the VM and the occurrence of a boot storm.

As a technique for leveling a load between nodes, a technique disclosed in US 2019/0253490 A is known. The technique disclosed in US 2019/0253490 A includes: predicting performance data that is of an application deployed on each cluster node and that is in a preset time period; calculating a first standard deviation of a cluster system according to the predicted performance data of each cluster node; when the first standard deviation of the cluster system is greater than a preset threshold, determining an application migration solution according to a resource load balancing rule; and sending the application migration solution to a cluster application manager to trigger the cluster application manager and perform resource load balancing control on the cluster system according to the application migration solution.

### SUMMARY OF THE INVENTION

In a computer system that adopts the HCI configuration, there is a case where a load on the node of the VM temporarily increases, and a bias occurs in usage rates of computing resources (a CPU, a memory, a disk, and a network) among nodes depending on the way of use by a user. At this time, the nodes of the VM are rearranged while preferentially eliminating the bias in the usage rates of the computing resources. As a result, the node on which the VM runs and the node storing data of the OS image used by the VM are different so that the VM accesses the data via a network connecting both the nodes. If the VM is restarted with this arrangement, a network load increases due to the large amount of disk access occurring at the time of starting up the OS. To start a large number of VMs on the node different from the node storing the data causes the boot storm.

The present invention has been made in view of the above circumstances, and an object thereof is to provide a computer system and a management method capable of suppressing an increase in network load at the time of starting up an operating system of a virtual machine.

In order to solve the above problems, a computer system according to one aspect of the present invention is a computer system including: a plurality of nodes; and a management device configured to be capable of communicating with each of the nodes. The node includes a node processor and a node storage unit. At least one virtual machine, configured to provide a virtual desktop environment for each of clients, runs in at least one of the nodes, and images of operating systems commonly used in a plurality of the virtual desktop environments is arranged in the node storage. The management device includes a processor and a storage unit. The processor rearranges the virtual machine arranged in the node with a high usage rate in the other node based on a standard deviation of the usage rate of the node processor in the plurality of the nodes, and selects the node in which a large number of the images of the operating systems used by the virtual machine are stored, arranges the virtual machine, and starts up the virtual machine when the client starts up the virtual machine and the virtual machine reads the images from the node storage unit.

According to the present invention, it is possible to suppress the increase in network load at the time of starting up the operating system of the virtual machine.

### BRIEF DESCRIPTION OF THE DRAWINGS

FIG. 1 is a diagram illustrating a hardware configuration example of a computer system according to an embodiment;

FIG. 2 is a diagram illustrating a software configuration example of nodes constituting the computer system according to the embodiment;

FIG. 3 is a diagram illustrating a development example of an OS image of the computer system according to the embodiment;

FIG. 4 is a diagram illustrating a hardware configuration example of the nodes constituting the computer system according to the embodiment;

FIG. 5 is a view illustrating a configuration of a VM management table of the computer system according to the embodiment;

FIG. 6 is a view illustrating a configuration of a free resource management table of the computer system according to the embodiment;

FIG. 7 is a view illustrating a configuration of a volume management table of the computer system according to the embodiment;

FIG. 8 is a flowchart illustrating an operation of an arrangement node search program of the computer system according to the embodiment;

FIG. 9 is a view illustrating a configuration of a physical CPU usage rate table of the computer system according to the embodiment;

FIG. 10 is a view illustrating a configuration of a virtual CPU usage rate table of the computer system according to the embodiment;

FIG. 11 is a flowchart illustrating an operation of a VM rearrangement program of the computer system according to the embodiment; and

FIG. 12 is a flowchart illustrating an operation of a cluster management program at the time of restarting a VM of the computer system according to the embodiment.

### DESCRIPTION OF THE PREFERRED EMBODIMENTS

Hereinafter, an embodiment of the present invention will be described with reference to drawings. Incidentally, the embodiment to be described hereinafter do not limit the present invention according to the claims, and further, all of the elements described in the embodiment and combinations thereof are not necessarily indispensable for the solution of the invention.

In the following description, a “memory” represents one or more memories, and may typically be a main storage device. At least one memory in s memory unit may be a volatile memory or a nonvolatile memory.

In the following description, a “processor” represents one or more processors. The at least one processor is typically a microprocessor such as a central processing unit (CPU), but may be another type of processor such as a graphics processing unit (GPU). The at least one processor may be a single-core or multi-core processor.

In addition, the at least one processor may be a processor in a broad sense such as a hardware circuit that performs some or all of processes (for example, a field-programmable gate array (FPGA) or an application specific integrated circuit (ASIC)).

In the present disclosure, the storage device includes one storage drive such as one hard disk drive (HDD) or solid state drive (SSD), a RAID device including a plurality of storage drives, and a plurality of RAID devices. When the drive is the HDD, a serial attached SCSI (SAS) HDD or a nearline SAS (NL-SAS) HDD, for example, may be included.

In the following description, information in which an output can be obtained with respect to an input is sometimes described using an expression of an “xxx table”, but the information may be data having an arbitrary structure or may be a learning model such as a neural network that generates an output for an input. Therefore, the “xxx table” can be referred to as an “xxx information”.

In the following description, a configuration of each table is an example, one table may be divided into two or more tables, or all or some of two or more tables may be one table.

In the following description, processing will be sometimes described using a “program” as a subject. The subject of the processing may be the program since the program is executed by a processor to perform the prescribed processing appropriately using a storage resource (for example, a memory) and/or an interface device (for example, a port). The processing described with the program as the subject may be processing performed by a processor or a computer having the processor.

The program may be installed on a device such as a computer, or may be provided, for example, on a program distribution server or a computer-readable (for example, non-temporary) recording medium. In the following description, two or more programs may be realized as one program, or one program may be realized as two or more programs.

Incidentally, the same reference signs will be attached to portions having the same function in the entire drawing for describing the embodiment, and the repetitive description thereof will be omitted.

In the following description, a reference sign (or a common sign among reference signs) is used in the case of describing the same type of elements without discrimination, and identification numbers (or reference signs) of the elements are used in the case of describing the same type of elements with discrimination.

Positions, sizes, shapes, ranges, and the like of the respective components illustrated in the drawings do not always indicate actual positions, sizes, shapes, ranges and the like in order to facilitate understanding of the invention. Therefore, the present invention is not necessarily limited to the positions, sizes, shapes, ranges, and the like disclosed in the drawings.

A computer system of the present embodiment may have the following configuration as an example.

That is, when receiving a VM creation request (including the number of CPU cores used by a VM, a memory capacity used by the VM, and OS information used by the VM) from an infrastructure administrator, a managing node (management device) of the computer system preferentially selects a node, which stores an OS image and allocates a CPU core and a memory capacity to the VM as a node in which the VM is to be arranged.

For example, when a bias occurs in a usage rate of a computing resource between nodes during operation, a VM running on a node with the highest usage rate of the computing resource is migrated to a node with the lowest usage rage of computing resource to eliminate the bias in the usage rate of the computing resource between the nodes.

When restarting a VM, the VM is migrated between nodes to a node storing the OS image used by the VM and starting the VM regardless of the arrangement of the VM before shutdown, and then, the VM is started up to reduce a network load that occurs at the time of starting up an OS and suppress the occurrence of a boot storm. After starting up the OS, the VM is migrated again to an arrangement node immediately before shutdown of the VM such that the node arrangement of the VM is suitable for operation.

<Configuration of Computer System>

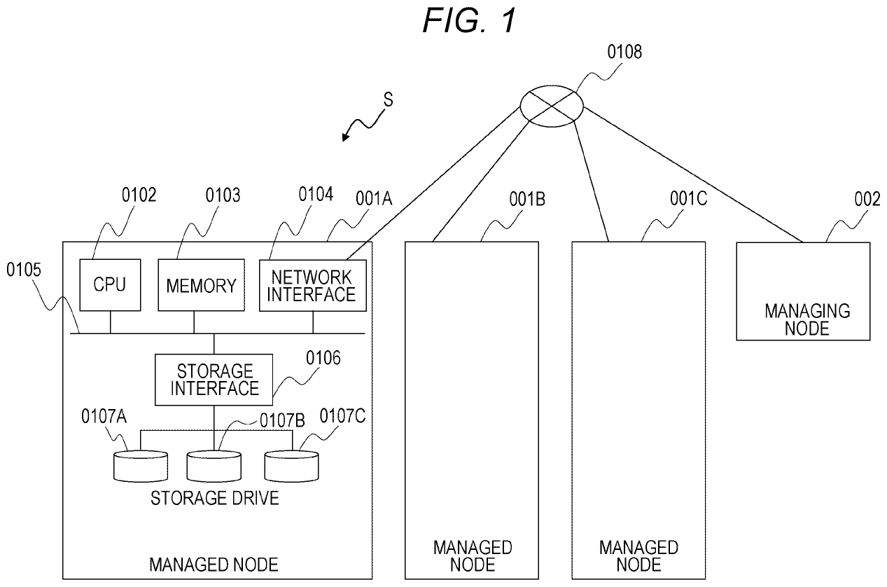

FIG. 1 is an example of the computer system for carrying out the present invention, and illustrates a hardware configuration example when a plurality of nodes operate as a cluster.

FIG. 1 is the hardware configuration example of a distributed storage system (computer system) S which is the cluster that realizes an HCI configuration, the cluster including a plurality of managed nodes 001A, 001B, and so on and a managing node (management device) 002 that manages the managed nodes.

Each of the managed nodes 001A, 001B, and so on includes, for example, a CPU 0102 which is a node processor, a memory 0103, a network interface 0104, an internal bus 0105, a storage interface 0106, storage drives 0107A, 0107B, and so on as computing resources.

The managing node 002 and the managed nodes 001 are connected to each other via a network 0108, and the managing node 002 groups the managed nodes 001 under its control. These nodes communicate with each other to operate as the cluster.

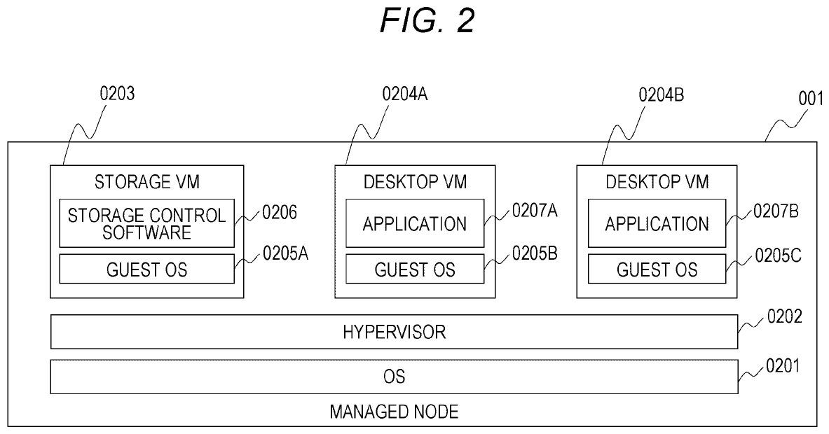

In virtual desktop infrastructure (VDI) adopting the HCI configuration, a virtual machine (VM) that provides storage control software and a VM that provides a user desktop environment run on the same node. FIG. 2 illustrates a software configuration example of the managed node 001 in the VDI adopting the HCI configuration.

In this configuration, an OS 0201 runs to control the hardware of the managed node 001 and a hypervisor 0202 runs on the OS 0201. The hypervisor 0202 runs a VM on the managed node 001. The VM is a virtual computer that reproduces computer hardware (for example, a CPU, a memory) by software. A plurality of VMs are arranged on the hypervisor, and the plurality of VMs run in parallel. In addition, the OS and applications run on the VM in the same manner as a normal computer. A plurality of VMs running on the same node share computing resources (a CPU, a memory, a volume, and the like) of the node.

On the managed node 001, a storage VM 0203 and desktop VMs 0204A, 0204B, and so on run in parallel.

In the storage VM 0203, a guest OS 0205A runs, and storage control software 0206, which provides a storage for a desktop VM on the cluster, runs.

Guest OSs 0205B, 0205C, and so on run on the desktop VMs 0204A, 0204B, and so on. The VDI may adopt, for example, a form in which one desktop VM is provided as a desktop environment dedicated to one user or a form in which one desktop VM is provided as a desktop environment shared by a plurality of users.

Applications 0207A, 0207B, and so on run on the OSs 0205B, 0205C, and so on of the desktop VMs 0204A, 0204B, and so on. For example, the application is installed arbitrarily by a user on a virtual desktop in some cases, or is included in the OS image in advance in other cases.

Although the VM is used as an environment for running the storage control software in the present embodiment, the storage control software can also run directly on the OS 0201 of the node 001. In such a case, the storage VM 0203 and the guest OS 0205A become unnecessary.

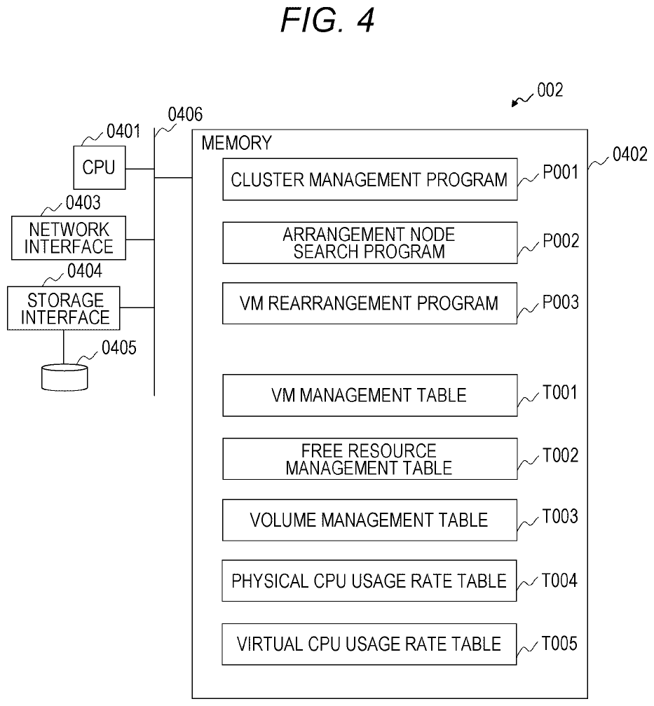

FIG. 4 illustrates a hardware configuration of the managing node 002. The managing node 002 includes a CPU 0401 as a processor, a memory 0402, a network interface 0403, a storage interface 0404, a disk 0405, and a bus 0406 connecting these parts.

The memory 0402 includes a cluster management program P001, an arrangement node search program P002, a VM rearrangement program P003, a VM management table T001, a free resource management table T002, a volume management table T003, a physical CPU usage rate table T004, and a virtual CPU usage rate table T005.

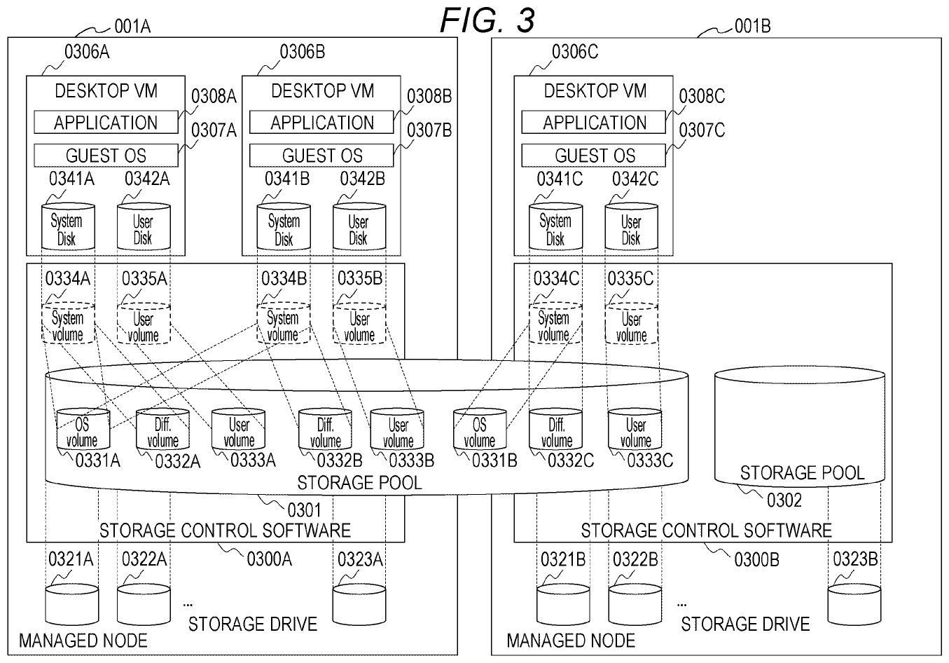

The cluster management program P001 manages an ID of each of the plurality of managed nodes 001A, 001B, and so on constituting the cluster, computing resources thereof, and a managing node ID. In addition, the cluster management program P001 manages VM IDs of desktop VMs 0306A, 0306B, 0306C, and so on running on the managed nodes 001A, 001B, and so on on the cluster. In addition, the cluster management program P001 manages IDs of volumes 0331A, 0332A, 0333A, and so on created by storage control software 0300A, 0300B, and so on on the cluster (see FIG. 3).

The arrangement node search program P002 searches for and determines the managed nodes 001A, 001B, and so on in which VMs are to be arranged and the managed nodes 001A, 001B, and so on in which volumes as storage destinations of data of VM applications are to be arranged when there is the VM creation request in a procedure to be described later.

The VM rearrangement program P003, the physical CPU usage rate table 1004, and the virtual CPU usage rate table 1005 will be described later.

When the same OS runs on the plurality of desktop VMs 0306A, 0306B, 0306C, and so on on the cluster, it is more desirable to share the same OS image area on the storage system with the plurality of desktop VMs and store only write data of the individual desktop VMs 0306A, 0306B, 0306C, and so on in a differential area than to secure the OS image area on the storage system for each of the desktop VMs 0306A, 0306B, 0306C, and so on, from the viewpoint of capacity efficiency, and the latter form is generally used in operating the VDI.

FIG. 3 illustrates an example of a method for deploying an OS image on a desktop VM in the VDI adopting the HCI configuration.

The storage control software 0300A divides a capacity of each of a plurality of physical storage devices 0321A, 0322A, 0323A, and so on on the managed node 001A into fixed-size areas, and combines these divided areas to create a storage pool 0301. The storage control software 0300B also divides a capacity of each of a plurality of physical storage devices 0321B and 0322B on the node 001B into fixed-size areas, and adds the divided areas to the storage pool 0301. In this manner, the storage pool 0301 can be constituted by the physical storage devices 0321A, 0321B, and so on of the plurality of managed nodes 001A and 001B.

A plurality of storage pools can be created on the cluster and on the managed nodes 001A, 001B, and so on. The storage control software 0300B has a storage pool 0302 in addition to the storage pool 0301, divides the capacity of each of the plurality of physical storage devices 0323B and so on on the managed node 001B into fixed-size areas, and combines these divided areas to create the storage pool 0302.

The storage control software 0300A, 0300B, and so on combine the fixed-size areas on the storage pools 0301, 0302, and so on to create volumes, and store these volumes as a system disk and user disk of a desktop VM. Actual data of the created volume is distributed and stored in one or more physical storage devices constituting the storage pools 0301, 0302, and so on. In a case where a storage pool is constituted by physical storage devices of a plurality of nodes (for example, in the case of the storage pool 0301), actual data of one volume is sometimes distributed and stored in physical storage devices on the plurality of managed nodes 001A and 001B.

In the VDI where the OS image is shared by the plurality of desktop VMs, for example, an “OS volume” storing the OS image used by the desktop VM, a “differential volume” to which a configuration change added to the OS by a user of the desktop VM and application data installed by the user are written, and a “user volume” configured to store data created by the user in an application on the same VM exist on the storage pool.

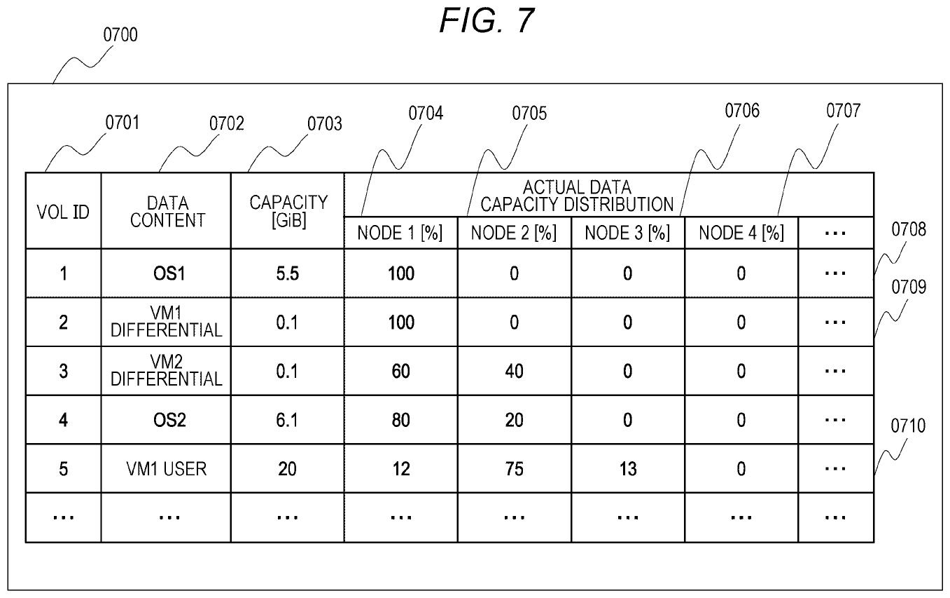

FIG. 7 illustrates a configuration example of the volume management table 1003 (700) created by the managing node 002.

The volume management table 0700 describes a content of volume data, a capacity, and a node distribution of volume data for all the volumes existing on all the storage pools on the managed nodes 001A, 001B, and so on.

An ID of the volume on the storage pool is denoted by 0701. The data content of the volume is denoted by 0702. As an example of the data content, the OS volume is described as “OS1” in the case of storing an image of OS1 and as “OS2” in the case of storing the image of OS2, the differential volume is described as “VM1 differential” in the case of being used for data storage of Desktop VM 1 and as “VM2 differential” in the case of being used for data storage of Desktop VM 2, and the user volume is describe as “VM1 user” in the case of being used to store user data of Desktop VM 1. The capacity of the volume is described in 0703. The data distribution of the volume is described in 0704, 0705, 0706, 0707, and so on, which describes what percentage of data of the volume is stored in the physical storage device of each of the managed nodes 001A, 001B, and so on.

When a management user stores the image of OS1 on a node, the managing node 002 requests storage control software 0300 to create an OS volume. The storage control software creates the OS volume 0331A by combining fixed-size areas constituting the storage pools 0301 and 0302, and stores the OS image on the same volume. The managing node 002 adds an entry to the volume management table 0700, assigns an ID to the volume, describes the data content of the volume, inquires the storage control software about a capacity of the volume and a node distribution of actual data of the volume, and then, describe theses capacity and node distribution. An example of management information of the OS volume 0331A is denoted by 0708, which illustrates that the VOL ID of the volume is 1, the data content is the OS image of OS1, the capacity is 5.5 GiB, and 100% of actual data, that is, the entire data is stored in the physical storage device on Node 1.

When the desktop VM 0306A is created and arranged on the managed node 001A, the storage control software 0300A of this managed node 001A creates the differential volume 0332A to store write data with respect to the system disk of the desktop VM on the storage pools 0301 and 0302, creates the virtual volume 0334A in combination with OS volume 0331A, and allocates the virtual volume 0334A as a system disk 0341A of the desktop VM 0306A.

The managing node 002 adds an entry to the volume management table 0700, assigns an ID to the newly created differential volume 0332A, describes the data content of this differential volume 0332A, inquires the storage control software 0300 about a capacity of the differential volume 0332A and a distribution of actual data capacity of the differential volume 0332A, and then, describes these capacity and distribution. An example of management information of the differential volume 0332A is denoted by 0709, which illustrates that the VOL ID of the volume is 2, the data content is difference data of the system disk of the desktop VM (VM ID is 1), the capacity is 0.1 GiB, and 100% of actual data, that is, the entire data is stored in the physical storage device on Node 1.

The managed node 001 that allocates computing resources (the number of CPU cores and the memory capacity) to a desktop VM is called an arrangement node of the same VM.

When the entire data of the volume used by a desktop VM is stored in the arrangement node of the same VM (that is, the managed node 001A) as in the correspondence among the desktop VM 0306A, the OS volume 0331A, and the differential volume 0332A, an I/O operation on the volume of the desktop VM is processed only within the same node, and thus, can be executed at high speed.

When the desktop VM 0306A is created and arranged on the managed node 001A, the storage control software 0300A of the managed node 001A creates the user volume 0333A to store user data of the desktop VM on the storage pool 0301, creates a virtual volume 0335A, and allocates the volume 0335A as a user disk 0342A of the desktop VM 0306A at the same time.

The managing node 002 adds an entry to the volume management table 0700, assigns an ID to the user volume 0333A, describes the data content of the user volume 0333A, inquires the storage control software 0300 about a capacity of the user volume 0333A and a distribution of actual data capacity of the user volume 0333A, and then, describe these capacity and distribution. An example of management information of the user volume 0333A is denoted by 0710, which illustrates that the VOL ID of the same volume is 5, the data content is user data of the desktop VM (VM ID is 1), the capacity is 20 GiB, and the actual data capacity is distributed such that 12% is stored in the physical storage device on Node 1, 75% is stored in the physical storage device on Node 2, and 13% is stored in the physical storage device on Node 3.

When data of a volume used by a desktop VM is also stored in a node different from the arrangement node of the VM as in the correspondence between the desktop VM 0306A and the user volume 0333A, the storage control software 0300 on the arrangement node of the VM transfers a part of the I/O operation issued by the VM with respect to the volume to the storage control software 0300 of the node that stores the data of the volume. In order to reduce a network load as much as possible and reduce the disk access latency of the VM to the disk, it is desirable to arrange the VM on a node that stores data of the disk most.

Next, a description will be given with reference to FIG. 3 regarding an example of an operation of converting I/O issued by a desktop VM with respect to a system disk into a read process with respect to an OS disk and a read/write process with respect to a differential disk constituting a volume corresponding to the system disk by taking a case of starting up the desktop VM 0306A as an example and using the system disk 0341A of the desktop VM 0306A, the virtual volume 0334A corresponding to the system disk 0341A, and the OS volume 0331A and the differential volume 0332A constituting the virtual volume 0334A.

When the desktop VM 0306A is started up, this VM reads an OS image from the system disk 0341A.

A read process for an address on the system disk 0341A is converted by the storage control software 0300A to a read process for a corresponding address of the virtual volume 0334A. The storage control software 0300A records an address where the write process was performed in the past on the volume 0334A, and determines whether another write process occurred for a target address in the past if a read process occurs for the volume 0334A. The read process is converted to a read process for the corresponding address of the differential volume 0332A if an affirmative determination is made, and is converted to a read process for the corresponding address of the OS volume 0331A if a negative determination is made (if the write process was not performed in the past).

When the guest OS 0307A is started up on the desktop VM 0306A, the settings of the OS are changed by a user, and data is written to the system disk 0341A. A write process for an address on the system disk 0341A is converted by the storage control software 0300A to a write process for a corresponding address of the volume 0334A. If the write process for the corresponding address of the volume 0334A is new, the storage control software 0300A allocates a new fixed-size area that constitutes the storage pool 0301 to the differential volume 0332A, performs the write process to the volume 0334A as a write process to the differential volume 0332A, and stores the correspondence between the address of the volume 0334A and an address of the area allocated on the differential volume 0332A.

If another write process was already performed to the corresponding address of the volume 0334A in the past, the storage control software 0300A performs the write process to the volume 0334A as a write process to an address on the corresponding differential volume 0332A.

The differential volume 0332A consumes the fixed-size area on the storage pool 0301 only after data is written to the system disk 0341A by the desktop VM 0306A, and thus, the capacity consumed by the differential volume 0332A on the physical disk is smaller than that of the OS volume 0331A.

In the case of creating the desktop VM 0306B that executes the same guest OS as the desktop VM 0306A, the storage control software 0300A of the node 001A creates a differential volume 0332B on the storage pool 0301, combines the OS volume 0331A and the differential volume 0332B to create a virtual volume 0334B, and allocates the virtual volume 0334B as a system disk 0341B of the desktop VM 0306B, which is similar to the desktop VM 0306A. Further, the storage control software 0300A creates a user volume 0333B on the storage pool 0301, creates a virtual volume 0335B, and allocates the virtual volume 0335B as a user disk 0342B of the desktop VM 0306B.

When the desktop VM 0306B is started up, the OS image is read from the OS volume 0331A, user settings and the like are read from the differential disk 0332B, the same OS as the guest OS 0307A is started up as a guest OS 0307B, and an application 0308B runs on the same OS. Data created by the application 0308B is written to the user disk 0342B.

Since the storage control software 0300 shares the OS volume that stores the OS image among the plurality of desktop VMs, and records only the write data of the desktop VM in the differential volume assigned to each of the desktop VMs in this manner, the physical disk capacity can be used more efficiently as compared with a case of creating volumes storing OS images separately for the respective desktop VMs.

Note that the above differential volume does not exist, and write to a system disk by a user is directly reflected as write to an OS volume in VDI where the respective desktop VMs have separate OS volumes.

When the user stores an OS, which is different from an OS stored in the OS volume 0331A, in the storage pool 0301, the storage control software 0300A creates a new OS volume 0331B and stores an OS image on the same volume.

Further, in the case of creating a desktop VM 0306C that uses the OS image stored in the OS volume 0331B on the node 001B, the storage control software 0300B of the node 001B creates a differential volume 0332C on a storage pool, combines the OS volume 0331B and the differential volume 0332C to create a virtual volume 0334C, and allocates the virtual volume 0334C as a system disk 0341C of the desktop VM 0306C. Further, the storage control software 0300B creates a user volume 0333C on the storage pool 0301, creates a virtual volume 0335C, and allocates the virtual volume 0335C as a user disk 0342C of the desktop VM 0306C.

When the desktop VM 0306C is started up, the OS image is read from the OS volume 0331B, user settings and the like are read from the differential disk 0332C, a guest OS 0307C is started up, and an application 0308C runs on the same OS. Data created by the application 0308C is written to the user disk 0342C.

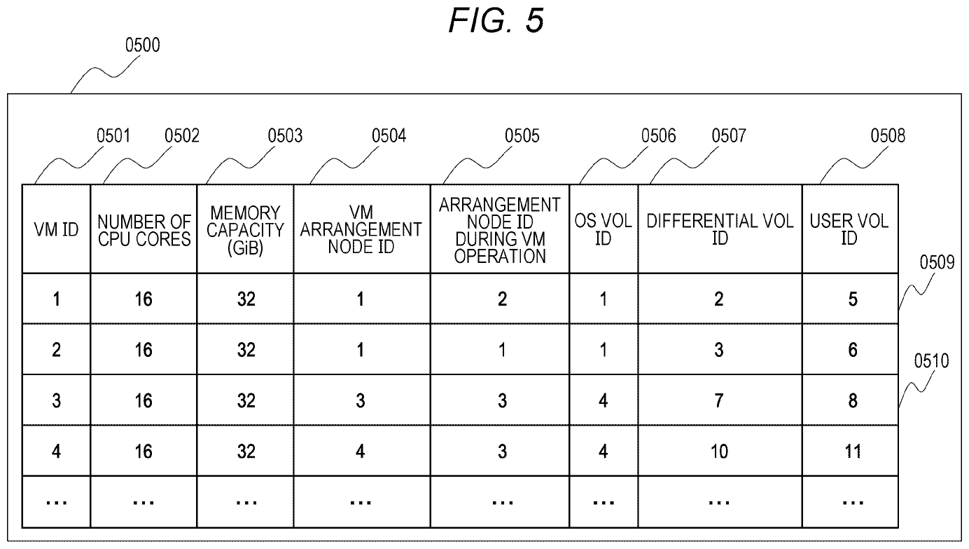

FIG. 5 illustrates an example of the VM management table T001 (0500) in the computer system having the software configuration of FIG. 2. The VM management table 0500 describes management information for each of the desktops VM 0306A, 0306B, and so on.

An ID of a desktop VM is described in 0501. The number of CPU cores allocated to a desktop VM is denoted by 0502. A memory capacity allocated to a desktop VM is denoted by 0503. An ID of a currently arranged VM arrangement node of a desktop VM is denoted by 0504. An ID of a node to be arranged during operation of a desktop VM is denoted by 0505. A VOL ID of an OS volume storing an OS image that constitutes a system disk of a desktop VM is denoted by 0506. A VOL ID of a differential volume that constitutes a system disk of a desktop VM is denoted by 0507. A VOL ID of a user volume assigned to a user disk of a desktop VM is denoted by 0508.

In 0509, it is illustrated that the ID of the desktop VM is 1, the number of CPU cores consumed by the desktop VM is “16”, the memory capacity consumed by the desktop VM is “32 GiB”, the arrangement node ID of the desktop VM is 1, the arrangement node ID during the operation of the desktop VM is 2, the system disk of the desktop VM is constituted by the OS volume whose VOL ID is 1 and the differential volume whose VOL ID is 2, and the user disk of the desktop VM is configured using the user volume whose VOL ID is 5.

In 0511, it is illustrated that the ID of the desktop VM is 3, the number of CPU cores consumed by the desktop VM is “16”, the memory capacity consumed by the desktop VM is “32 GiB”, the arrangement node ID of the desktop VM is 3, the arrangement node ID during the operation of the desktop VM is 3, the system disk of the desktop VM is constituted by the OS volume whose VOL ID is 4 and the differential volume whose VOL ID is 7, and the user disk of the desktop VM is configured using the user volume whose VOL ID is 11.

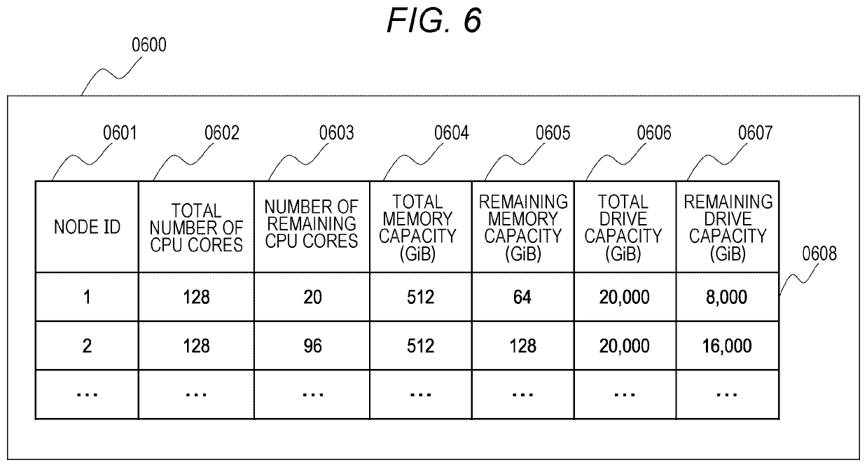

FIG. 6 illustrates a configuration example of the free resource management table 1002 (0600). The free resource management table 0600 describes free resources for each of the managed nodes 001A, 001B, and so on

An ID of a managed node is described in 0601. The total number of CPU cores of a managed node is denoted by 0602. The number of remaining CPU cores unallocated to VMs among all the CPU cores of a managed node is denoted by 0603. A total memory capacity of a managed node is denoted by 0604. A remaining memory capacity unallocated to VMs out of the total memory capacity of a managed node is denoted by 0605. A total drive capacity of a managed node is denoted by 0606. A drive capacity unallocated to VMs out of a total drive capacity of a managed node is denoted by 0607.

In 0608, it is illustrated that the ID of the managed node is 1, the total number of CPU cores of the managed node is “128”, and the number of unallocated CPU cores of the managed node is currently “20”, the total memory capacity of the managed node is “512 GiB”, and the unallocated memory capacity of the managed node is currently “64 GiB”, the total drive capacity of the managed node is “20000 GiB” and the unallocated drive capacity of the managed node is currently “8000 GiB”.

The cluster management program P001 periodically inquiries about the total number of CPU cores of the managed node, the number of unallocated CPU cores of the managed node, the total memory capacity of the managed node, the unallocated memory capacity of the managed node, the total drive capacity of the managed node, and the unallocated drive capacity of the managed node per managed node, and updates the information on the free resource management table 0600.

<Initial Arrangement of VM>

Next, an operation to initially arrange a new desktop VM on a managed node, which is performed by the managing node 002, will be described. The managing node 002 arranges the new desktop VM on a managed node that stores the most data of the OS volume of the same VM as long as the managed node has the enough remaining amount of computing resources (the number of CPU cores, the memory capacity, and the disk capacity).

The cluster management program P001 receives a desktop VM creation request from a management user terminal. This request includes the number of CPU cores required by the desktop VM, the memory capacity required by the desktop VM, and a name of an OS used by the desktop VM. The cluster management program P001 requests the arrangement node search program P002 to search for an arrangement node of the new desktop VM.

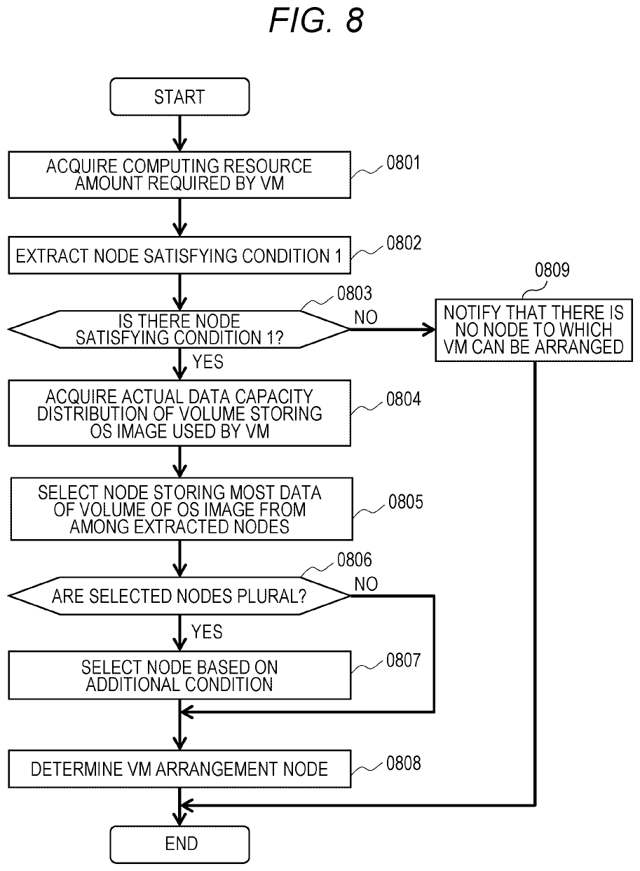

FIG. 8 is a flowchart illustrating an example of an operation when the arrangement node search program P002 searches for the arrangement node of the new desktop VM.

The arrangement node search program P002 receives an arrangement node search request from the cluster management program P001. This request includes the number of CPU cores required by the desktop VM, the memory capacity required by the desktop VM, and the name of the OS used by the desktop VM (0801).

The arrangement node search program P002 refers to the free resource management table 0600 and searches for and extracts managed nodes that satisfy Condition 1 “the number of CPU cores required by the VM and the memory capacity required by the VM can be allocated to the new desktop VM” (0802). Based on this result, the arrangement node search program P002 determines the presence or absence of the corresponding nodes (0803).

If the arrangement node search program P002 makes an affirmative determination, the arrangement node search program P002 refers to the volume management table 0700 and acquires an inter-node distribution of actual data capacity of the entire OS volume storing OS images used by the newly created desktop VM (0804).

The arrangement node search program P002 extracts a node that stores the most OS volume data from among the nodes extracted in Step 0802 based on the distribution of the actual data capacity of the volume acquired in Step 0804 (0805).

The arrangement node search program P002 determines whether there are a plurality of nodes extracted in Step 0805 (0806), and selects one node from the extracted nodes when an affirmative determination is made (0807). The operation of selecting one node from the plurality of nodes may be performed, for example, by selecting a node having the largest number of remaining CPU cores from the free resource management table 0600, by referring to the free resource management table 0600 to calculate each of a ratio of remaining CPU cores based on the total number of CPU cores and the number of remaining CPU cores, a ratio of the remaining memory capacity based on the total memory capacity and the remaining memory capacity, a ratio of the remaining disk capacity ratio based on the total disk capacity and the remaining disk capacity, for each node, calculate an average of the ratio of remaining CPU cores, the ratio of the remaining memory capacity, and the ratio of the remaining disk capacity to obtain a remaining computing resource ratio of each node, and selecting a node with a highest remaining computing resource ratio, or by notifying the management user of that there are a plurality of nodes satisfying the condition and causing the management user to explicitly select one node.

Next, the arrangement node search program P002 determines the selected node as a VM arrangement node for the new desktop VM, and notifies the cluster management program P001 of an ID of the VM arrangement node and an ID of the OS volume (0808).

If the arrangement node search program P002 makes a negative determination in Step 0803, it notifies that it is difficult to arrange the new desktop VM due to lack of computing resources (0809).

When receiving the VM arrangement node ID of the newly created desktop VM and the ID of the OS volume from the arrangement node search program P002, the cluster management program P001 asks the VM arrangement node to create the new desktop VM, and notifies a storage control software of the same node of the ID of the OS volume used by the new desktop VM to ask for creation of a system volume to be used by the new desktop VM.

The storage control software creates a new differential disk on a storage pool, creates a virtual volume in combination with the OS volume specified by the cluster management program P001, and connects the virtual volume to the new desktop VM as the system disk. At the time of creation, no data is written from the desktop VM to the differential disk, and a data area of the differential disk does not consume the capacity on a physical disk. In addition, the storage control software creates a new user volume on the storage pool, creates a virtual volume, associates the user volume and the virtual volume with each other, and connect the virtual volume to the new desktop VM as a user disk.

When the new desktop VM is created, the cluster management program P001 adds a new entry to the VM management table 0500, assigns an ID of the desktop VM, describes the number of CPU cores allocated to the desktop VM, a memory capacity allocated to the desktop VM, an arrangement node ID during VM operation of the desktop VM, a VOL ID of the OS volume constituting the system disk of the desktop VM, a VOL ID of the differential volume constituting the system disk of the desktop VM, and a VOL ID of the user volume corresponding to the user disk of the desktop VM, and also describes the VM arrangement node ID of the desktop VM as the arrangement node ID during VM operation of the desktop VM.

<Rearrangement of VM>

There is a case where a load on a computing resource varies between managed nodes depending on how the user uses a desktop VM after starting the operation of the desktop VM. In this case, the desktop VM is migrated (rearranged) between the managed nodes to level the load variation between the managed nodes.

The migration of the desktop VM between the managed nodes may be executed by the cluster management program P001, for example, as the management user explicitly issues a desktop VM migration request including an ID of the desktop VM to be moved and a node ID of a migration destination to a cluster managing node.

In addition, the cluster management program P001 may periodically perform the migration of the desktop VM based on a usage rate of a computing resource of each node. Here, an example of a method of automatically performing rearrangement between managed nodes so as to eliminate a bias in CPU resource usage rate will be described.

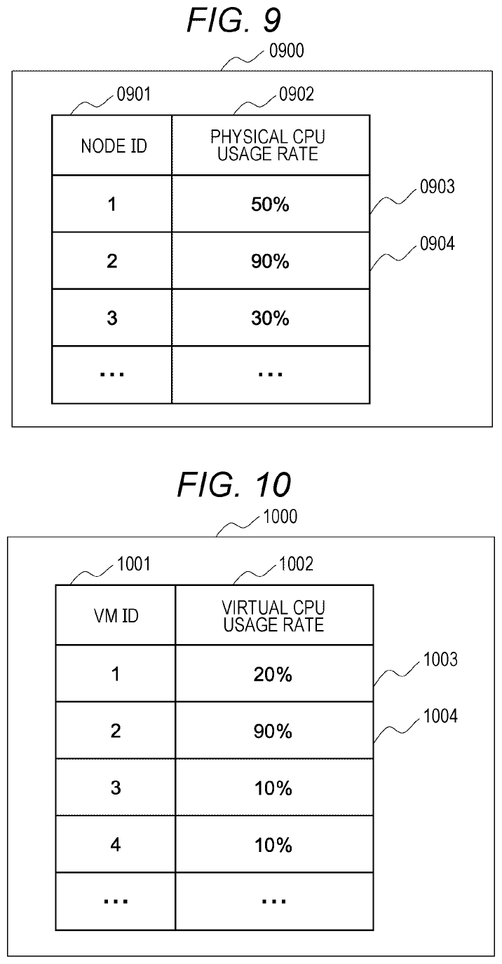

FIG. 9 illustrates an example of the physical CPU usage rate table 1004 (0900). The physical CPU usage rate table 0900 describes a physical CPU usage rate of each of managed nodes constituting a cluster.

An ID of a managed node is described in 0901. A physical CPU usage rate of a managed node is described in 0902. The physical CPU usage rate is a ratio of a processing amount consumed by all desktop VMs on a managed node relative to a processing amount that can be handled by all CPU cores available on the managed node.

In 0903, it is illustrated that 50% of a processing amount that can be handled by all CPU cores of Managed Node 1 is consumed by a desktop VM arranged in Managed Node 1.

In 0904, it is illustrated that 90% of a processing amount that can be handled by all CPU cores of Managed Node 2 is consumed by a desktop VM arranged in Managed Node 2.

FIG. 10 illustrates an example of the virtual CPU usage rate table 1005 (1000) of the VM. The virtual CPU usage rate table 1000 describes a virtual CPU usage rate of each desktop VM operating in the cluster.

An ID of the desktop VM is described in 1001. A virtual CPU usage rate of a desktop VM is described in 1002. The virtual CPU usage rate is a ratio of a processing amount consumed by all applications on a desktop VM relative to a processing amount that can be handled by all CPU cores assigned to the desktop VM.

In 1003, it is illustrated that 20% of a processing amount that can be handled by CPU cores allocated to Desktop VM 1 is consumed by an application running on Desktop VM 1.

In 1004, it is illustrated that 90% of a processing amount that can be handled by CPU cores allocated to Desktop VM 2 is consumed by an application running on Desktop VM 2.

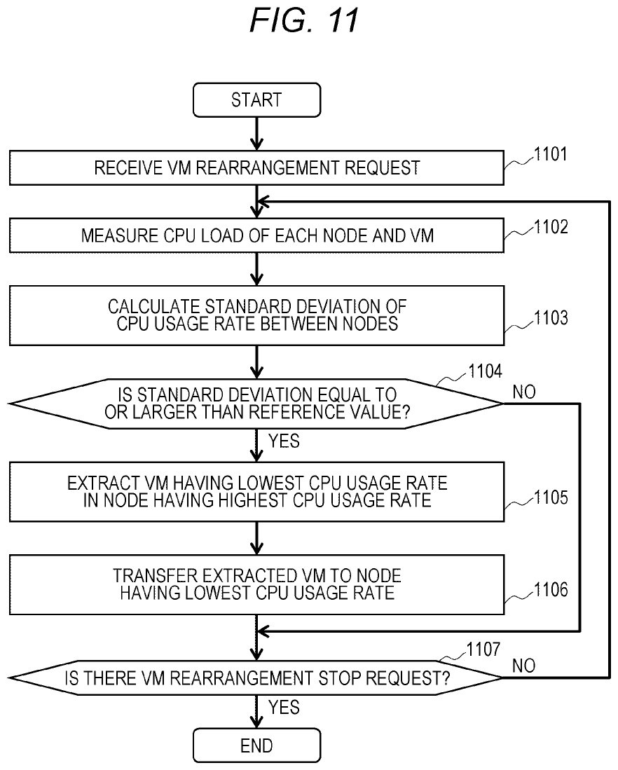

FIG. 11 is a flowchart illustrating an example of a desktop VM rearrangement operation performed by the managing node 002 in order to eliminate a bias in the CPU usage rate between managed nodes.

The VM rearrangement program P003 receives a VM rearrangement request between the managed nodes from the management user terminal (1101).

In Step 1102, the VM rearrangement program P003 measures a physical CPU usage rate of a managed node and a virtual CPU usage rate of the desktop VM running on the managed node. This measurement includes, for example, a process in which the VM rearrangement program P003 acquires the physical CPU usage rate and the virtual CPU usage rate at regular time intervals for a certain period of time (for example, acquires both the usage rates from each node every second for one minute) from each of the managed nodes constituting the cluster, calculates an average physical CPU usage rate of the respective managed nodes based on physical CPU usage rate data of each managed node, and similarly calculates an average virtual CPU usage rate of the respective desktop VMs based on virtual CPU usage rate data of each desktop VM.

The VM rearrangement program P003 describes the average physical CPU usage rate of the respective managed nodes in the physical CPU usage rate table 0900, and describes the average virtual CPU usage rate of the respective desktop VMs in the virtual CPU usage rate table 1000.

Next, the VM rearrangement program P003 refers to the physical CPU usage rates of the respective managed nodes based on the physical CPU usage rate table 0900, and calculates its standard deviation (1103).

When detecting that the standard deviation calculated in Step 1103 is equal to or greater than a predetermined reference value (1104), the VM rearrangement program P003 extracts a desktop VM with the lowest virtual CPU usage rate arranged in a managed node with the highest physical CPU usage rate by referring to the desktop VM arrangement node ID in the VM management table 0500 and the virtual CPU usage rate table 1000 (1105). If there are a plurality of extracted desktop VMs, one of the desktops VM is selected. At this time, a desktop VM may be randomly selected, or a desktop VM having a smaller VM ID may be selected.

The VM rearrangement program P003 extracts a managed node with the highest physical CPU usage rate and a managed node with the lowest physical CPU usage rate based on the physical CPU usage rate table 0900, and requests the cluster management program P001 to migrate the desktop VM selected in Step 1105 from the managed node with the highest CPU usage rate to the managed node with the lowest physical CPU usage rate. The cluster management program P001 requests both the managed nodes to migrate the corresponding desktop VM between the managed nodes, and updates the VM arrangement node ID of the corresponding desktop VM and the arrangement node ID during VM operation of the corresponding desktop VM in the VM management table 0500 to migration destination node IDs of the corresponding desktop VM after the migration is completed (1106).

The VM rearrangement program P003 determines whether or not a VM rearrangement stop request has been issued from the management user terminal (1107), stops the rearrangement of the desktop VM if an affirmative determination is made, and performs the measurement of the CPU usage rate in Step 1102 again if a negative determination is made.

In this example, the procedure for automatically performing the rearrangement when leveling the physical CPU usage rates between managed nodes has been described. However, in order to level the memory usage rate between managed nodes, memory usage rates of the managed nodes and desktop VMs may be acquired, a standard deviation of the memory usage rates between the managed nodes may be calculated to be used as a trigger for the rearrangement, and a desktop VM to be moved may be determined based on the memory usage rates of the desktop VMs similarly.

In addition, a rearrangement procedure that focuses on disk access of a desktop VM during operation is conceivable. After an OS of a desktop VM is started up, data of a system disk is arranged on a memory of the desktop VM, and thus, I/O processing with respect to an OS volume is reduced as compared with the time of startup. On the other hand, an application uses data on a user disk, I/O processing with respect to a user volume occurs during the operation of the desktop VM. Therefore, during the operation of the desktop VM, it is desirable to arrange the desktop VM on a managed node that stores the most data of the user volume and reduce a network load between the managed nodes accompanying disk access to the user volume as much as possible.

For this purpose, the managing node 002 refers to the VM management table 0500 to acquire a VOL ID of the user volume constituting the user disk of the desktop VM, refers to the volume management table 0700 to extract a managed node that stores the most actual data of the same volume, and migrates the corresponding desktop VM to the managed node when computing resources (the number of CPU cores and the memory capacity) used by the desktop VM can be allocated by the managed node, and updates the VM arrangement node ID of the corresponding desktop VM and the arrangement node ID during VM operation of the corresponding desktop VM in the VM management table 0500 to the same managed node ID to which the corresponding desktop VM is migrated.

<Arrangement when Restarting VM>

As a result of the desktop VM rearrangement described above, a desktop VM is arranged on a node that does not store data of an OS volume. When the desktop VM is restarted on the node, disk access via the network between managed nodes occurs when reading the data from the OS volume. If the rearrangement is performed for many desktop VMs, the network load increases, which causes the boot storm.

In the present embodiment, when a desktop VM is restarted, the boot storm is suppressed by performing the restart after migrating the desktop VM to a managed node that stores the most data of its OS image regardless of the managed node arrangement immediately before shutdown. After the desktop VM is restarted, the desktop VM is migrated again to a node in which the desktop VM has been arranged immediately before shutdown to restore the managed node arrangement appropriate during operation (the managed node arrangement of the VM that levels the load between the managed nodes during operation).

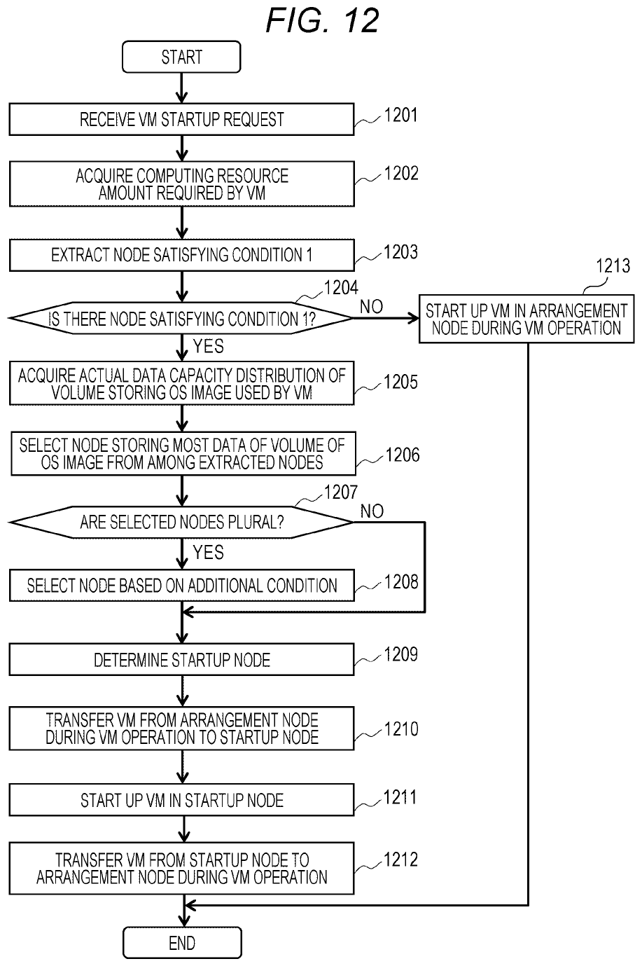

FIG. 12 is a flowchart illustrating an example of a series of operations at the time of restarting the desktop VM performed by the cluster management program P001.

When receiving a request for starting up a desktop VM from a user terminal (1201), the cluster management program P001 acquires the number of CPU cores of the corresponding desktop VM, a memory capacity required by the desktop VM, and a name of an OS used by the desktop VM from the VM management table 0500 (1202).

The cluster management program P001 refers to the free resource management table 0600 and searches for and extracts managed nodes that satisfy Condition 1 “the number of CPU cores required by the VM and the memory capacity required by the VM can be allocated to the desktop VM” (1203). Based on this result, the cluster management program P001 determines the presence or absence of the corresponding managed node (1204).

If the cluster management program P001 makes an affirmative determination, the cluster management program P001 refers to the volume management table 0700 and acquires a distribution of actual data capacity between managed nodes of the entire OS volumes storing OS images of the desktop VM to be started up (1205).

The cluster management program P001 extracts a managed node that stores the most OS volume data from among the managed nodes extracted in Step 1203 based on the distribution of the actual data capacity of the volume acquired in Step 1205 (1206).

The cluster management program P001 determines whether there are a plurality of managed nodes extracted in Step 1206 (1207), and selects one managed node from the extracted managed nodes when an affirmative determination is made (1208).

The operation of selecting one managed node from the plurality of managed nodes may be performed, for example, by selecting a managed node having the largest number of remaining CPU cores from the free resource management table 0600, by referring to the free resource management table 0600 to calculate each of a ratio of remaining CPU cores based on the total number of CPU cores and the number of remaining CPU cores, a ratio of the remaining memory capacity based on the total memory capacity and the remaining memory capacity, a ratio of the remaining disk capacity ratio based on the total disk capacity and the remaining disk capacity, for each managed node, calculate an average of the ratio of remaining CPU cores, the ratio of the remaining memory capacity, and the ratio of the remaining disk capacity to obtain a remaining computing resource ratio of each managed node, and selecting a managed node with a highest remaining computing resource ratio, or by notifying the management user of that there are a plurality of managed nodes satisfying the condition and causing the management user to explicitly select one managed node.

Next, the cluster management program P001 determines the selected managed node as a “startup node” of the desktop VM to be started up (1209).

Next, the cluster management program P001 refers to VM management table 0500 to acquire the arrangement node ID during VM operation, which is the arrangement node immediately before shutdown of the desktop VM to be started up, requests the startup node selected in Step 1209 and the acquired arrangement node during VM operation to migrate the corresponding desktop VM to the startup node between the nodes, and updates the VM arrangement node ID of the desktop VM to be started up in VM management table 0500 to an ID of the startup node after the migration is completed. At this time, the arrangement node ID during VM operation of the corresponding desktop VM in the VM management table 0500 is not changed (1210).

Next, the cluster management program P001 requests the startup node to start up the corresponding desktop VM (1211). Whether the startup of the OS of the desktop VM is completed is determined, for example, such that the cluster management program P001 instructs a storage control program of the startup node to monitor and notify the amount of disk I/O with respect to the OS volume of the corresponding desktop VM, and it is determined that the startup of the OS of the corresponding desktop VM is completed when the amount of disk I/O falls below a predefined threshold.

After the startup of the OS of the corresponding desktop VM is completed, the cluster management program P001 refers to VM management table 0500 to acquire the arrangement node during VM operation of the corresponding desktop VM, requests the startup node and the acquired arrangement node during VM operation to migrate the corresponding desktop VM to the arrangement node during VM operation between the nodes, and updates the VM arrangement node ID of the corresponding desktop VM in the VM management table 0500 to an ID of the arrangement node during VM operation after the migration is completed (1212).

If the cluster management program P001 makes a negative determination in Step 1204, the desktop VM to be started up is not migrated between the nodes and is started up on the arrangement node during VM operation (1213).

According to the present embodiment configured in this manner, it is possible to suppress the increase in the network load at the time of starting up the OS of the desktop VM. That is, when the desktop VM is restarted, the VM is started up on the node storing the OS image data, and thus, it is possible to reduce the network load caused by the disk access and suppress the occurrence of the boot storm.

Incidentally, the configuration has been described in detail in the above embodiment in order to describe the present invention in an easily understandable manner, and is not necessarily limited to one including the entire configuration that has been described above. Further, addition, deletion, or substitution of other configurations can be made with respect to some configurations of each embodiment.

A part or all of each of the above-described configurations, functions, processing units, processing means, and the like may be realized, for example, by hardware by designing with an integrated circuit and the like. The present invention can also be realized by a program code of software for realizing the functions of the embodiment. In this case, a storage medium in which the program code has been recorded is provided to a computer, and a processor included in the computer reads the program code stored in the storage medium. In this case, the program code itself read from the storage medium realizes the functions of the above embodiment, and the program code itself and the storage medium storing the program code constitute the present invention. As the storage medium configured to supply such a program code, for example, a flexible disk, a CD-ROM, a DVD-ROM, a hard disk, a solid state drive (SSD), an optical disk, a magneto-optical disk, CD-R, a magnetic tape, a nonvolatile memory card, a ROM, or the like is used.

The program code for realizing the functions described in the present embodiment can be implemented by a wide range of programs or script languages such as assembler, C/C++, Perl, Shell, PHP, and Java (registered trademark).

In the above embodiment, control lines and information lines are considered to be necessary for the description have been illustrated, and it is difficult to say that all of the control lines and information lines required as a product are illustrated. All the configurations may be connected to each other.

What is claimed is:

1. A computer system comprising:
a plurality of nodes; and
a management device configured to be capable of communicating with each of the nodes,
wherein the node comprises a node processor and a node storage unit,
at least one virtual machine, configured to provide a virtual desktop environment for each of clients, runs in at least one of the nodes, and images of operating systems commonly used in a plurality of the virtual desktop environments is arranged in the node storage,
the management device comprises a processor and a storage unit, and
the processor
rearranges the virtual machine arranged in the node with a high usage rate in the other node based on the usage rate of the node processor in the plurality of the nodes, and
selects the node in which a large number of the images of the operating systems used by the virtual machine are stored, arranges the virtual machine, and starts up the virtual machine when the client starts up the virtual machine and the virtual machine reads the images from the node storage unit.

2. The computer system according to claim 1, wherein
the images of the operating systems used by the single virtual machine are distributed and arranged on the plurality of the nodes.

3. The computer system according to claim 1, wherein
the processor
creates a volume management table describing a capacity of the image of the operating system stored in each of the nodes and stores the volume management table in the storage unit, and
refers to the volume management table to allocate the virtual machine to the node.

4. The computer system according to claim 3, wherein
the processor refers to the volume management table to identify the node in which the images of the operating systems used by the virtual machine are stored most.

5. The computer system according to claim 1, wherein
the processor arranges the virtual machine on the node in which the images of the operating systems used by the virtual machine are stored most and starts up the virtual machine, and then, rearranges the virtual machine to the node in which the virtual machine has been arranged immediately before being shut down.

6. The computer system according to claim 5, wherein
the processor creates a virtual machine management table describing any of the nodes in which each of the virtual machines has been arranged, and stores the virtual machine management table in the storage unit.

7. The computer system according to claim 6, wherein
the processor refers to the virtual machine management table to identify the node in which the virtual machine has been arranged immediately before being shut down.

8. A management method in a computer system including a plurality of nodes and a management device configured to be capable of communicating with each of the nodes,
the node including a node processor and a node storage unit,
at least one virtual machine, configured to provide a virtual desktop environment for each of clients, running in at least one of the nodes, and images of operating systems commonly used in a plurality of the virtual desktop environments being arranged in the node storage, and
the management device including a processor and a storage unit,
the management method of causing the processor
to rearrange the virtual machine arranged in the node with a high usage rate in the other node based on the usage rate of the node processor in the plurality of the nodes, and
to select the node in which a large number of the images of the operating systems used by the virtual machine are stored, arrange the virtual machine, and start up the virtual machine when the client starts up the virtual machine and the virtual machine reads the images from the node storage unit.
